(19) United States
(12) Patent Application Publication
(10) Pub. No.: US 2006/0155048 A1
(43) Pub. Date: Jul. 13, 2006

(54) Thermostabilizer for plastics

(75) Inventor: Guenther Ittmann, Gross-Umstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Roehm GMBH & Co. KG, Darmstadt (DE)

(21) Appl. No.: 10/528,178

(22) PCT Filed: Apr. 17, 2004
(86) PCT No.: PCT/EP04/04088

§ 371 Date: Mar. 17, 2005

(30) Foreign Application Priority Data
Jul. 31, 2003 (DE) 103 35 578.2

(51) Int. Cl. C08L 31/00

(52) U.S. Cl. 524/556; 524/115; 526/319

(57) ABSTRACT

The alkylamino salt of mono- or dialkyl-substituted phosphoric acid can be used as heat stabilizer in polymers.

### FIELD OF THE INVENTION

The invention relates to heat stabilizers for plastics, in particular heat stabilizers for transparent plastics, such as polymethyl methacrylate (PMMA).

### PRIOR ART

It is known that plastics sheets can be produced via polymerization of suitable monomers and/or monomer mixtures, which may also be a prepolymerized syrup, in cells with walls composed of glass plates, e.g. float glass.

The glass plates usually form the floor and the ceiling of the cells, and the cells are sealed at the side by suitable means, such as flexible beads or tapes composed of material resistant to the monomer.

The produces are marketed with the name Plexiglass® GS by Röhm GmbH & Co. KG.

Prior Art

Heat stabilizers are known. For example, organotin compounds or lead compounds are used for stabilizing polyvinyl chloride (PVC). The organotin compounds bind the hydrogen chloride which forms during thermal decomposition. A disadvantage of the organotin compounds is their toxicity. Substituted ureas or epoxy compounds may also be used. (Saechtling: Kunststoff Taschenbuch [Plastics handbook], 26^{th} edition, Carl-Hanser-Verlag (1995), p. 575). Thermal degradation of PMMA may be reduced via addition of small amounts of p-methoxyphenylethacrylamide or diphenylmethacrylamide. (Kunststoff-Handbuch [Plastics handbook], Vol. IX, p. 398, Carl-Hanser-Verlag, 1975).

JP 62089756 (Mitsubishi Rayon) describes a type of PMMA which is stabilized using sodium dodecyl phosphate, disodium monooctadecyl phosphate and disodium mono(3,6-dioxyoctadecyl) phosphate.

### DISADVANTAGES OF THE PRIOR ART

Some of the substances used as heat stabilizers are acid-labile and cannot therefore be used in monomer formulations which comprise acidic monomers, such as (meth)acrylic acid.

Object And Achievement Of Object

It was therefore an object to find an internal heat stabilizer which does not require the solubilizer benzyl alcohol with its disadvantages, and which can also be used in acid-containing monomer compounds.

Achievement Of Object

It has been found that a compound of the general formula I
Rₙ¹PO₃^{√}(HN⁻—R₃²)ₘ
where:
n=1 or 2
m=2 or 1 and n+m=3,
   where if m=1 the anion has a single negative charge and if m=2 the anion has a double negative charge,

R¹=methyl, ethyl, propyl, isopropyl, butyl, isobutyl, pentyl, hexyl, heptyl, octyl, nonyl, decyl, undecyl, or dodecyl

R²=methyl, ethyl, propyl, isopropyl or butyl,

exhibits good heat-stabilizing action when used in amounts of from 0.001 to 0.5% by weight in a polymerizable monomer mixture.

As polymerizable monomer mixture, use may be made of methyl methacrylate and monomers copolymerizable with MMA.

Polymerizable monomer mixtures are tert. compositions which comprise ethylenically unsaturated monomers and/or prepolymerized monomers (syrups). These compositions preferably comprise monomers or syrups which are suitable for producing what may be called organic glass or synthetic glass.

Among the abovementioned ethylenically unsaturated monomers which may be present in the polymerizable monomer mixtures are vinyl esters, esters of acrylic acid, e.g. methyl acrylate and ethyl acrylate, esters of methacrylic acid, e.g. methyl methacrylate, butyl methacrylate and ethylhexyl methacrylate, vinyl chloride, vinylidene chloride, vinyl acetate, styrene, substituted styrenes having an alkyl substituent in the side chain, e.g. α-methylstyrene and α-ethylstyrene, substituted styrenes having an alkyl substituent on the ring, e.g. vinyltoluene and p-methylstyrene, halogenated styrenes, e.g. monochlorostyrenes, dichlorostyrenes, tribromostyrenes and tetrabromostyrenes, vinyl ethers and isopropenyl ethers, maleic acid derivatives, e.g. maleic anhydride, methylmaleic anhydride, maleimide, methyl maleimide, and dienes, such as 1,3-butadiene and divinylbenzene, preference being given to acrylic esters, methacrylic esters, vinyl acetate, vinyl chloride, vinylidene chloride, styrene, α-methylstyrene, halogen-substituted styrenes, vinyl ethers, isopropenyl ethers and dienes, and very particular preference being given to methyl methacrylate.

Very particularly preferred embodiments of the inventive process feature the use, as polymerizable composition, of a (meth)acrylate-containing resin with the following composition

(meth)acrylate (A) from 20 to 99.9% by weight,

comonomers (B) from 0.0 to 79.9% by weight,

polymers (C), soluble

in (A) or in (B) from 0 to 70.0% by weight

and, based on 100 parts of the abovementioned components:

initiators from 0.01 to 5 parts by weight

and also other conventional

processing aids from 0 to 10 pares by weight.

(Meth)acrylate means acrylic and/or methacrylic compounds, as mentioned above by way of example.

Comonomers are compounds copolymerizable with (meth)-acrylates. Among these are the abovementioned monomers other than (meth)acrylate. By way of example, polymers which may be present dissolved in the polymerizable composition are polymers or copolymers of the above-mentioned monomeric constituents. Initiators and processing aids are described below.

The abovementioned monomers may also be used as mixtures, and also in prepolymerized form, as what may be called syrups.

All of the abovementioned monomers are commercially available. However, they may also be prepared by any method known to the person skilled in the art.

The polymerizable compositions may comprise the conventional additives.

By way of example, mention may be made of the following additives: antistatic agents, antioxidants, mould-release agents, flame retardants, lubricants, dyes, flow improvers, fillers, light stabilizers and organic phosphorus compounds, such as phosphites or phosphonates, pigments, weathering stabilizers and plasticizers.

The amount used of the additives is conventional, i.e. up to 80% by weight, preferably up to 30% by weight, based on the total weight. If the amount is greater than 80% by weight, based on the total weight, properties of the polymerizable composition, e.g. processability, may be impaired.

According to the invention, the polymerizable composition is poured into a mould whose inner surface is composed at least to some extent of inorganic glass.

Mould means any of the moulds which are usually used. This mould may have been assembled from various components, where one component of the mould has a glass surface. The expression “at least to some extent” means that the proportion of the glass surface, based on the entire inner surface of the mould, is at least 10%, preferably more than 30% and very particularly preferably more than 80%.

By way of example, one preferred mould encompasses two glass plates, a ceiling plate and a base plate, the sides of which are separated and sealed by suitable measures, e.g. tapes or flexible beads. By way of example, the glass plates may be held together by metal clamps and have an area of 2 m*3 m and a thickness of from about 2 to 20 mm, preferably from 3 to 12 mm. There are also what may be called multiple cells, in particular twin cells, which have a layered structure, the central glass plates being in contact on both sides with the polymerizable composition.

Inorganic glass for the mould materials encompasses in particular cooled melts which, by way of example, may comprise silicone dioxide (SiO₂), calcium oxide (CaO), sodium oxide (Na₂O), sometimes with relatively large amounts of boron trioxide (B₂O₃), aluminium oxide (Al₂O₃), lead oxide (PbO), magnesium oxide (MgO), barium oxide (BaO), potassium oxide (K₂O) and other additives.

Once the mould has been filled, the polymerizable composition is polymerized to give a moulding. Polymerization here means any of the processes known to persons skilled in the art and taking place in bulk, for example bulk polymerization, which is described by way of example in Houben-Weyl, volume E20, Part 2 (1987), p. 1145 et seq.

The polymerization may take place by a free-radical or ionic route, free-radical polymerization being preferred. It may use heat, radiation, and initiators, preference being given to the use of initiators which form free radicals. The particular conditions of polymerization depend on the monomers selected and on the initiator system, and are well-known to persons skilled in the art.

Among the preferred initiators are the azo initiators well-known to persons skilled in the art, e.g. AIBN or 1,1-azobiscyclohexanecarbonitrile, and also peroxy compounds, e.g. methyl ethyl ketone peroxide, acetylacetone peroxide, ketone peroxide, methyl isobutyl ketone peroxide, cyclohexanone peroxide, dibenzoyl peroxide, tert-butyl peroxybenzoate, tert-butylperoxy isopropyl carbonate, 2,5-bis(2-ethyl-hexanoylperoxy)-2,5-dimethylhexane, tert-butylperoxy 2-ethylhexanoate, tert-butylperoxy 3,5,5-trimethylhexanoate, 1,1-bis(tert-butylperoxy)cyclohexane, 1,1-bis(tert-butylperoxy) 3,3,5-trimethylcyclohexane, cumyl hydroperoxide, tert-butyl hydroperoxide, dicumyl peroxide, bis(4-tert-butylcyclohexyl) peroxydicarbonate, mixtures of two or more of the abovementioned compounds with one another, and also mixtures of the abovementioned compounds with compounds not mentioned which can likewise form free radicals.

Once the moulding has been obtained, this is demoulded, i.e. removed from the mould. This procedure is dependent on the mould used and is known per se to persons skilled in the art.

It has now been found that the reaction product, by way of example, of a mixture of monononyl (from 30 to 35% by weight) and dinonyl (from 65 to 70% by weight) phosphate with triethylamine, used in the form of pure material, has a heat-stabilizing action on the plastics moulding. Furthermore, the inventive product is acid-resistant, and this property permits its use in formulations which comprise acidic components, e.g. methacrylic acid, acrylic acid or stearic acid. HALS products (hindered amine light stabilizers), such as Tinuvin 770 (Ciba) are acid-labile. The batch becomes cloudy.

Use of the Inventive Compound as Heat Stabilizer

The inventive compound is a suitable heat stabilizer for polymers, in particular for PMMA.

Mention may be made of the following other polymers for which the inventive compound can provide heat stabilization: polycarbonate (PC), PET, PE, polystyrene (PS), etc. The amount used here of the inventive compound, based on the polymer, is from 0.0001 to 5% by weight, preferably from 0.00055 to 5% by weight, and very particularly preferably from 0.001 to 5% by weight.

### EXAMPLES

1. Preparation of the Inventive Product

1600 g of the mixture of monononyl (from 30 to 35% by weight) and dinonyl (from 65 to 70% by weight) phosphate (Zelec® UN, producer: DU PONT) form an initial charge in a reaction flask, and 492.3 g of triethylamine is added dropwise, with stirring. A temperature of >50° C. is reached during this exothermic reaction. After the dropwise addition, stirring is continued for a further 30 min. This gives a clear reaction product with a slight yellow tint.

2. Preparation of a Methyl Methacrylate (MMA)—PMMA Syrup

MMA is treated with 0.07% by weight of bis(4-tert-butylcyclohexyl) peroxydicarbonate, and the material is dissolved, with stirring. 50% of the solution are heated to about 90° C., with stirring. The other 50% of the solution are fed into the heated solution in such a way as not to exceed a temperature of 93° C. The reaction is then allowed to continue for a further period of about 2-3 min, and then the MMA-PMMA syrup is rapidly cooled to room temperature. The polymer content of the syrup is about 20%, and has a molecular weight of about 170 000.

2. Effective of the inventive product on heat-conditioning behaviour (30 min at 200°) of the resultant acrylic sheet: (visual assessment).

Example 1: no alteration visible

Example 2: very uneven surfaces—very major surface bubble formation on both sides.

Examples of the Use of the Inventive Product as Heat Stabilizer

### Example 1

A cell is built using 2 silicate glass panes of dimensions 40×50 cm and a round PVC bead of thickness 3.6 mm, the cell being held together by metal clamps. The space within this cell is filled with the following polymerization mixture:
0.05% by weight of inventive compound of the formula I, where:
   n=2
   m=1
   R¹=methyl
   R²=ethyl
0.08% by weight of 2,2-azobis(isobutyronitrile) 99.87% by weight of MMA-PMMA syrup

The additives are dissolved in the MMA-PMMA syrup, with stirring. Once the cell has been sealed, the polymerization is carried out for 17 h at 45° C. in a water bath. The metal clamps and the round bead are then removed, and the polymerization reaction in the cells is carried out over a period of 3 h at 115° in a heat-conditioning cabinet. After cooling to room temperature, the glass panes were removed and demoulding of the acrylic sheet from the glass panes was assessed.

### Example 2

The procedure was as in Example 1 with addition of 0.10% of the inventive compound.

A cell is built using 2 silicate glass panes of dimensions 40×50 cm and a round PVC bead of thickness 3.6 mm, the cell being held together by metal clamps. The space within this cell is filled with the following polymerization mixture:
0.05% by weight of inventive compound of the formula I, where:
   n=2
   m=1
   R¹=methyl
   R²=ethyl
0.08% by weight of 2,2-azobis(isobutyronitrile) 99.87% by weight of MMA-PMMA syrup

The additives are dissolved in the MMA-PMMA syrup, with stirring. Once the cell has been sealed, the polymerization is carried out for 17 h at 45° C. in a water bath. The metal clamps and the round bead are then removed, and the polymerization reaction in the cells is carried out over a period of 3 h at 115° in a heat-conditioning cabinet. After cooling to room temperature, the glass panes were removed.

### Example 3

The procedure was as in Example 1 without addition of the inventive compound.

Result:

Effect of the inventive product on the heat-conditioning behaviour (30 min at 200° C.) of the resultant acrylic sheet: (visual assessment).

Heat resistance measurement (weight loss) to DIN ISO 11358:

| Example | Td (2% weight loss) in ° C |
|---|---|
| 1 | 281 |
| 2 | 280 |
| 3 | 209 |

The examples show a clear increase in the temperature at which the weight loss from the specimen reaches 2%.

1. Use of the compound
Rₙ¹PO₃^{√}(HN⁻—R₃²⁾ₘ(I)
as heat stabilizer during the cast polymerization of methyl methacrylate mixtures, where:
R¹=methyl, ethyl, propyl, isopropyl, butyl, isobutyl, pentyl, hexyl, heptyl, octyl, nonyl, decyl, undecyl, dodecyl
R²=methyl, ethyl, propyl, isopropyl, butyl
n=1 or 2
m=2 or 1

2. Use of the compound of the formula I in amounts of from 0.001 to 5.0% by weight, based on the weight of the polymerizable monomers or of the monomer mixture, as heat stabilizer.

3. Plastics moulding produced using a compound of the formula I.
